(19) United States
(12) Patent Application Publication
(10) Pub. No.: US 2006/0013591 A1
(43) Pub. Date: Jan. 19, 2006

(54) Receiver for angle-modulated optical signals

(76) Inventor: Harald Rohde, Munchen (DE)

Correspondence Address: Siemens Corporation;Intellectual Property Department, 170 Wood Avenue South, Iselin, NJ, 08830, US

(21) Appl. No.: 10/533,664

(22) PCT Filed: Oct. 13, 2003
(86) PCT No.: PCT/DE03/03385

§ 371 Date: May 3, 2005

(30) Foreign Application Priority Data
Nov. 7, 2002 (DE) 102 51 889.0

(51) Int. Cl. H04B 10/00

(52) U.S. Cl. 398/152

(57) ABSTRACT

The invention relates to a receiver for an angle-modulated optical signal, whereby the angle-modulated optical signal is injected into an optical resonator. Reflected light escapes from the optical resonator on a phase or frequency change of the angle-modulated optical signal. An optical decoupling device is arranged before the optical resonator, using an opto-electrical converter for determining an angular change in the reflected light from the optical resonator. Various forms of decoupling devices for recovery of the reflected light are described.

### CROSS REFERENCE TO RELATED APPLICATIONS

This application is the US National Stage of International Application No. PCT/DE2003/003385, filed Oct. 13, 2003 and claims the benefit thereof. The International Application claims the benefits of German application No. 10251889.0 filed Nov. 7, 2002, both applications are incorporated by reference herein in their entirety.

### FIELD OF THE INVENTION

The invention relates to a receiver for angle-modulated optical signals.

### BACKGROUND OF THE INVENTION

Existing optical transmission systems modulate the information to be transmitted onto the intensity of the light used for transmission. In a receiving system, a photodiode converts the optical amplitude-modulated signals into electrical signals. In certain configurations or parameter ranges of an optical transmission system, it may be found advantageous to modulate the information onto the phase or frequency of the light to be transmitted. In this case a simple photodiode is no longer sufficient to extract the information from the phase- or frequency-modulated signals.

There have hitherto existed two basic concepts for phase detection of optical light fields. Both concepts have a number of advantages and disadvantages and are used in a number of variations

The first concept is based on homodyne reception. The incident light field of the phase-modulated optical signal is mixed with a second light field of the same frequency and having a defined phase (the following discussion will be limited to phase modulation for reasons of clarity). This second light field can be generated either by an external laser as a “local oscillator” or can also be a portion—delayed by one bit duration—of the transmitted light. This is known as “self-homodyne reception”. The two optical fields interfere constructively or destructively on a photodiode depending on the phase position of the fields, and the photodiode produces a current proportional to the square of the cosine of the relative phase position of the fields.

The second concept is based on heterodyne reception. The incident light field of the phase-modulated optical signal is mixed with a second light field of different frequency. Both optical fields interfere on a photodiode. The photodiode supplies an alternating current whose frequency corresponds to the differential frequency of the two optical fields and whose phase is provided by the phase of the transmitted optical field. An electrical phase detector produces an amplitude-modulated current from this alternating current signal.

In both cases an external laser or a portion (generally time-delayed by one bit duration) of the transmitted light field is used as the second light field.

Although an external laser has advantages in terms of receiver sensitivity, either the laser stability requirements are considerable (“homodyne detection”) or an additional electrical intermediate stage must be inserted (“heterodyne detection”).

Mixing the received light field with a time-delayed portion of the same field (“self-homodyne reception”) is the easiest to implement technologically. However, the receiver sensitivity is generally lower by a factor of 4 than in the case of detection using an external light source.

### SUMMARY OF THE INVENTION

The object of the invention is to specify a simple and sensitive receiver for determining the phase information from the transmitted light of an angle-modulated optical signal, and additionally to convert this phase information into an amplitude-modulated electrical signal.

This object is achieved by the claims.

The receiver according to the invention has an optical resonator for storing the optical field of the angle-modulated optical signal. A Fabry-Perot resonator known from “Laserspektroskopie, Grundlagen und Techniken (Laser spectroscopy, fundamentals and techniques), W. Demtröder, Springer, 2000” can be used as the optical resonator. The optical resonator is dimensioned so that the optical field storage time is approximately half of one bit duration. The transmission frequency of the optical resonator is tuned to the light frequency. For certain parameters, the half-power beamwidth of the transmission is in the region of a few GHz, which means that the tuning of the resonator frequency is not overly critical.

In a lossless optical Fabry-Perot resonator into which light is coupled at the resonance frequency, a strongly increased standing light field is produced. This light field penetrates the semi-transparent mirror of the resonator to the outside. At the side of the resonator at which the light from the angle-modulated optical signal is coupled in, the emergent field has the opposite phase to that of the incident field, so that it interferes destructively with the incident field and no light is reflected back into the input channel. The light emerging from the output side of the resonator experiences no interference from any other external light field. The resonator appears transparent to a constant light field at the resonance frequency.

If the phase of the incident light field varies by the value π, constructive interference will be created from the destructive interference at the resonator input and light will therefore be reflected back. See “Optical decay from a Fabry-Perot cavity faster than the decay time”, H. Rohde, J. Eschner, F. Schmidt-Kaler, R. Blatt, J. Opt. Soc. Am. B 19, 1425-1429, 2002.

The receiver is likewise suitable for both a frequency-modulated and a phase-modulated signal. The receiver can therefore be used generally as a receiver for an angle-modulated signal, i.e. using the phase or frequency. For reasons of simplicity, the following description will refer to a receiver for a phase-modulated signal.

The back-reflected light is separated from the input light by means of an optical coupling-out device such as a circulator or a combination of a polarization beam splitter and wave plate and is detected by means of an opto-electric transducer such as a photodiode. The photodiode current therefore constitutes a measure for determining a phase variation or change in the incident light.

Significant advantages of the receiver according to the invention are that the sensitivity is increased by up to a factor of 2 compared to self-homodyne reception while being only slightly more complex to implement than same and much simpler than solutions involving an additional laser.

Advantageous further developments of the invention are set forth in the dependent claims.

### BRIEF DESCRIPTION OF THE DRAWINGS

An example of the invention will now be explained in greater detail with reference to the accompanying drawings in which:

FIG. 1: shows the improvement factor of the signal-to-noise ratios between homodyne reception and the receiver according to the invention,

FIG. 2: shows a first receiver according to the invention,

FIG. 3: shows a second receiver according to the invention.

### DETAILED DESCRIPTION OF THE INVENTION

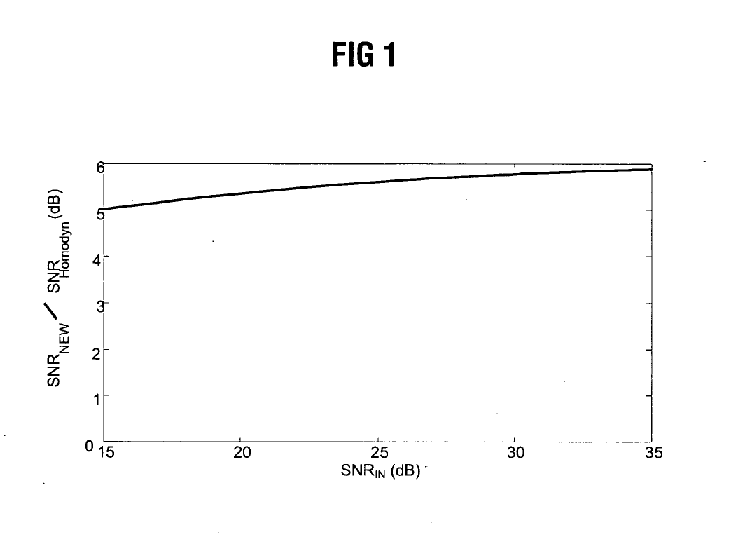

FIG. 1 shows the value of an improvement factor α of the signal-to-noise ratios between a conventional homodyne receiver and the receiver according to the invention as a function of the signal-to-noise ratios of the input light

$${SNR}_{In} = \frac{{E}_{S}^{2}}{{E}_{N}^{2}} ,$$

where E_{S} denotes the signal field and E_{N} denotes the noise field of the input signal at the optical resonator.

To clarify the invention in relation to the optical resonator, important resonator parameters will now be explained.

The characteristics of an optical Fabry-Perot resonator consisting of two mirrors with reflectivity R and spacing L are determined (in simplified form) by the following parameters:
1. A free spectral range FSR specifies the frequency spacing of the resonator modes.

$$FSR = \frac{C}{2 L}$$

where c is the speed of light.
2. A half-power beamwidth Δv of the resonance is given by

$$Δ𝓋 = \frac{C}{2 L} * \frac{1 - R}{n \sqrt{R}} .$$
3. This yields the following relationship for the finesse F as the quotient of the free spectral range FSR and the half-power beamwidth Δv:

$$F = \frac{FSR}{Δ𝓋} = \frac{n \sqrt{R}}{1 - R} \approx \frac{n}{1 - R} for R \approx 1.$$
4. A storage time τ of an optical Fabry-Perot resonator as the time after which the intensity of the field stored in the resonator has decreased by a factor 1/e after the input field has been switched off is given by:

$$τ = \frac{F * L}{n C}$$

With a resonator length of L=1 mm and a storage time of τ=50 PS (half bit duration at 10 Gbit/s) this results in a finesse of F=50, giving a mirror reflectivity R of approx. 0.94%. The free spectral width FSR is 150 GHz and the half-power beamwidth Δv=3 GHz.

The improved receive sensitivity of the receiver according to the invention will now be described in comparison with self-homodyne reception.

The optical input field is represented as the sum of the signal field E_{S} and the noise field E_{N}: E_{In}=E_{S}+E_{N}.

In the case of self-homodyne reception, a beam splitter divides the field into two sub-fields E₁, E₂:
E₁=1/\sqrt{2}E_{In}=1/\sqrt{2}(E_{S}+E_{N})
E₂=1/\sqrt{2}E_{In}=1/\sqrt{2}(E_{S}+E_{N})

After one field has been delayed by one bit duration, the two fields are again added using another beam splitter and one of the outputs of the beam splitter is detected using a photodiode. It is assumed that the phase position has not changed and therefore the time delay need not be explicitly written into the formula.

The field E_{PD} at the photodiode location is:
E_{PD}=1/\sqrt{2}E₁+1/\sqrt{2}E₂

This yields the following relationship for the optical power P_{PD} at the photodiode location:
P_{PD}∝E_{PD}²=E_{S}²+E_{N}²+2E_{S}E_{N}

The signal-to-noise ratios SNR_{Ho mod yn} of self-homodyne reception are consequently:

$${SNR}_{Homodyn} = \frac{{E}_{S}^{2}}{{E}_{N}^{2} + 2 * {E}_{S} {E}_{N}} .$$

For the receiver according to the invention under steady state conditions inside the resonator, the field strength of the coherent input field E_{S} is increased by a factor of F/n, whereas the noise field penetrates the resonator attenuated only by a factor of 1−R), as the increasing does not take place in a coherent manner.

The field E_{Re s} inside the resonator is therefore:
E_{Re s}=F/n*Eₛ+(1−R)*E_{N}

The field E_{Res} inside the resonator penetrates the semi-transparent resonator mirror to the outside attenuated by a factor of (1−R). If the phase of the incoming field changes, the light emerging from the resonator no longer interferes destructively with the incident field and light leaves the optical resonator in the opposite direction to the incident light.

The field E_{Reflected} propagating in the opposite direction to the incident light consists of the portion of the input light field E_{IN} reflected at the resonator mirror and the portion of the light field E_{Res} stored in the resonator emerging through the semi-transparent resonator mirror.
E_{Re flected}=R*E_{IN}+(1−R)*E_{Res}
E_{Re flected}=R*(E_{S}+E_{N})+(1−R)*(F/nE_{S}+(1−R)*E_{N})
With F≈n/1−R and R≅1 and therefore 1−R)*(1−R)≅0 we get:
E_{Re flected}=2*E_{S}+E_{N}

The power P_{PD} at the photodiode is:
P_{PD}=E_{Re flected}²=4*E_{S}²+E_{N}²+4*E_{S}E_{N}

The signal-to-noise ratios SNR_{NEW} of the receiver according to the invention are consequently:

$${SNR}_{NEW} = \frac{4 * {E}_{S}^{2}}{{E}_{N}^{2} + 4 * {E}_{S} {E}_{N}}$$

The improvement factor α of the signal-to-noise ratios as between a conventional homodyne receiver and the receiver according to the invention can therefore be calculated:

$$\frac{{SNR}_{NEW}}{{SNR}_{Homodyn}} = \frac{{E}_{N}^{2} + 2 * {E}_{N} {E}_{S}}{{E}_{N}^{2} + 4 * {E}_{N} {E}_{S}} = α$$

The value of the improvement factor α depends on the signal-to-noise ratio

$${SNR}_{In} = \frac{{E}_{S}^{2}}{{E}_{N}^{2}}$$

of the input light. FIG. 1 shows the improvement factor α as a function of SNR_{In}.

The value for the improvement factor α applies to the time of the phase change, after which the signal reduces exponentially. Assuming that the photodiode and the evaluation electronics are not fast enough to detect only the peak value, but integrate over one bit duration, the improvement compared to self-homodyne reception must be reduced by a factor of 1/2−1/2*e²)=0.43

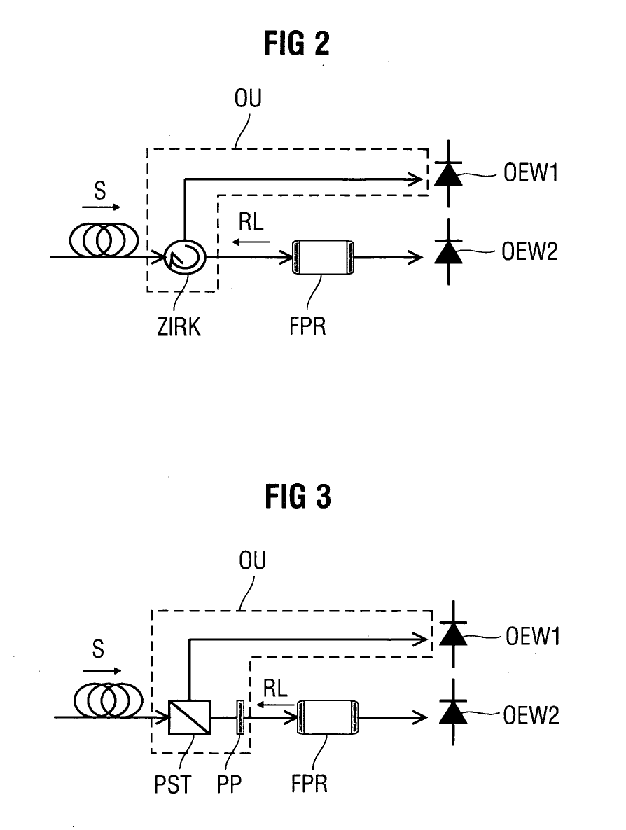

FIG. 2 shows a first receiver according to the invention for a phase-modulated optical signal S. The phase-modulated optical signal S is injected into an optical resonator FPR. The optical resonator FPR is preceded by an optical coupling-out device OU, using an opto-electric transducer OEW1 to determine any phase change in the phase-modulated optical signal S from the light RL reflected at the optical resonator FPR.

The optical resonator FPR can optionally be followed by a second opto-electric transducer OEW2, e.g. in the form of a photodiode, in order to increase the sensitivity by taking the difference of the signal or averaging the noise at the first opto-electric transducer OEW1.

For a frequency-modulated signal with a defined frequency deviation, a distinction can be made theoretically between the two following cases: in the case of a receiver using frequency modulation where the frequency deviation is smaller than the bandwidth of the optical resonator FPR, frequency modulation can be regarded in a similar manner to phase modulation; in the case of a receiver using frequency modulation where the frequency deviation is larger than the bandwidth of the optical resonator FPR, the optical resonator FPR will act as a frequency-selective mirror, i.e. a frequency is allowed through if it coincides with the resonance frequency of the optical resonator FPR and the other is reflected. On the two photodiodes OEW1, OEW2 two complementary binary signals would be picked up for detecting a sudden frequency change in the original frequency-modulated signal. The receiver according to the invention is well-suited in both cases.

The optical resonator FPR here is a conventional Fabry-Perot resonator. The optical coupling-out device OU has a circulator ZIRK which is connected preceding the optical resonator FPR and whose output is connected to the opto-electric transducer OEW1.

FIG. 3 shows a second receiver according to the invention in accordance with FIG. 2, where another type of optical coupling-out device OU is used. The optical coupling-out device OU has a polarization beam splitter PST with a following polarization plate PP so that the phase-modulated optical signal S and the reflected light RL have different polarizations which can be separated by the polarization beam splitter to determine any phase change.

Further variants of optical coupling-out devices OU can be implemented. The important factor is the recovery of the reflected light RL at the input of the optical resonator FPR. This reflected light provides information about any phase change in the modulated signal S. All other light components must be suppressed.

1-7. (canceled)

8. A receiver for an angle-modulated optical signal at a light frequency, which is injected into an optical resonator, wherein
the optical resonator is preceded by an optical coupling-out device for reflected light from the optical resonator, wherein
the optical coupling-out device is followed by an opto-electric transducer, and wherein, to determine a phase of the optical signal, the optical resonator has a resonance frequency which is tuned to the light frequency.

9. The receiver according to claim 8, wherein the optical resonator is a Fabry-Perot resonator.

10. The receiver according to claim 8, wherein the optical coupling-out device comprises a circulator connected preceding the optical resonator and whose output is connected to the opto-electric transducer.

11. The receiver according to claim 9, wherein the optical coupling-out device comprises a circulator connected preceding the optical resonator and whose output is connected to the opto-electric transducer.

12. The receiver according to claim 8, wherein the optical coupling-out device comprises a polarization beam splitter with a following polarization plate so that the angle-modulated optical signal and the reflected light have different polarizations which can be separated by the polarization beam splitter.

13. The receiver according to claim 9, wherein the optical coupling-out device comprises a polarization beam splitter with a following polarization plate so that the angle-modulated optical signal and the reflected light have different polarizations which can be separated by the polarization beam splitter.

14. The receiver according to claim 8, wherein a second opto-electric transducer is connected following the optical resonator in order to increase the sensitivity at the first opto-electric transducer.

15. The receiver according to claim 9, wherein a second opto-electric transducer is connected following the optical resonator in order to increase the sensitivity at the first opto-electric transducer.

16. The receiver according to claim 10, wherein a second opto-electric transducer is connected following the optical resonator in order to increase the sensitivity at the first opto-electric transducer.

17. The receiver according to claim 12, wherein a second opto-electric transducer is connected following the optical resonator in order to increase the sensitivity at the first opto-electric transducer.

18. The receiver according to claim 8, further comprising a coding for assigning a phase variation by the light reflected and as the case may be transmitted by the optical resonator.

19. The receiver according to claim 9, further comprising a coding for assigning a phase variation by the light reflected and as the case may be transmitted by the optical resonator.

20. The receiver according to claim 10, further comprising a coding for assigning a phase variation by the light reflected and as the case may be transmitted by the optical resonator.

21. The receiver according to claim 12, further comprising a coding for assigning a phase variation by the light reflected and as the case may be transmitted by the optical resonator.

22. The receiver according to claim 14, further comprising a coding for assigning a phase variation by the light reflected and as the case may be transmitted by the optical resonator.

23. A receiver for an angle-modulated optical signal having a light frequency, the receiver comprising:
an optical resonator fed by the angle-modulated optical signal;
an optical uncoupling mechanism arranged upstream of the optical resonator for light reflected from the optical resonator; and
an opto-electric converter arranged downstream of the optical uncoupling mechanism, wherein
the optical resonator has a resonance frequency adjusted to the light frequency for determining a phase of the optical signal.

24. The receiver according to claim 23, wherein the optical resonator is a Fabry-Perot resonator.

25. The receiver according to claim 23, wherein the optical uncoupling mechanism comprises a circulator arranged upstream of the optical resonator, and wherein an output of the circulator is connected to the opto-electric converter.

26. The receiver according to claim 23, wherein the optical uncoupling mechanism comprises a polarization beam splitter with a following polarization plate so that the angle-modulated optical signal and the reflected light have different polarizations which can be separated by the polarization beam splitter.

27. The receiver according to claim 23, further comprising a second opto-electric converter arranged downstream of the optical resonator for increasing sensitivity.
